(19) United States
(12) Patent Application Publication
(10) Pub. No.: US 2015/0115634 A1
(43) Pub. Date: Apr. 30, 2015

(54) Illuminated Pooper Scooper

(71) Applicant: Audrey Young, Pinion Hills, CA (US)

(72) Inventor: Audrey Young, Pinion Hills, CA (US)

(21) Appl. No.: 14/521,848

(22) Filed: Oct. 23, 2014

Related U.S. Application Data
(60) Provisional application No. 61/894,991, filed on Oct. 24, 2013.

(51) Int. Cl. E01H 1/12; F21L 4/04

(52) U.S. Cl. CPC E01H 1/1206; F21L 4/04; E01H 2001/1266; E01H 2001/1293; F21Y 2101/02
USPC 294/1.4

(57) ABSTRACT

An illuminated pet waste collection tool features two components: a small, flat-bottomed shovel blade and separate spatula of corresponding size and shape, each on a long handle. The two components clip together for carrying. The shovel component features a high-powered light-emitting diode (LED) bank in the handle, which is configured to selectively emit a bright, focused beam of light downward from the lower end of the handle to illuminate the ground in front of the user.

### CROSS-REFERENCE TO RELATED APPLICATIONS

This application claims priority to U.S. Provisional Application No. 61/894,991, filed Oct. 24, 2013, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to pet care accessories and in particular to an illuminated pooper scooper. Walking the dog after dark can be a difficult, and even dangerous task. There are obstacles to be tripped over, and of course the pet owner is usually required by local ordinances to collect the dog waste, day or night. The pet owner usually carries a flashlight for such nighttime dog walks, but it can be cumbersome and difficult to handle while controlling the dog and scooping up the dog waste. An illuminated pet waste collection tool would resolve this problem.

### SUMMARY OF THE INVENTION

Accordingly, the invention is directed to an illuminated pet waste collection tool. The device features two components: a small, flat-bottomed shovel blade and separate spatula of corresponding size and shape, each on a long handle. The two components clip together for carrying. The shovel component features a high-powered light-emitting diode (LED) bank in the handle, which is configured to selectively emit a bright, focused beam of light downward from the lower end of the handle to illuminate the ground in front of the user.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

FIG. 1 shows a front perspective view of the first exemplary embodiment, displaying the spatula component 10, the spatula blade 10A, the shovel component 11, the shovel blade 12, the shovel handle 13, the spatula handle 13A, the LED bank 14, the grip top 100, and the switch 102.

FIG. 2 shows a rear perspective view of the first exemplary embodiment, displaying the spatula component 10, the spatula blade 10A, the shovel component 11, the shovel blade 12, the shovel handle 13, the spatula handle 13A, the LED bank 14, the grip top 100, and the switch 102.

FIG. 3 shows a front perspective view of the first exemplary embodiment with the two components placed together, displaying the spatula component 10, the spatula blade 10A, the shovel component 11, the shovel blade 12, the shovel handle 13, the spatula handle 13A, the LED bank 14, the grip top 100, and the switch 102.

FIG. 4 shows a close up front view of the top of the shovel component of the first exemplary embodiment with the battery compartment open, displaying the shovel handle 13, the grip top 100, the switch 102, the battery compartment 400, and the batteries 401.

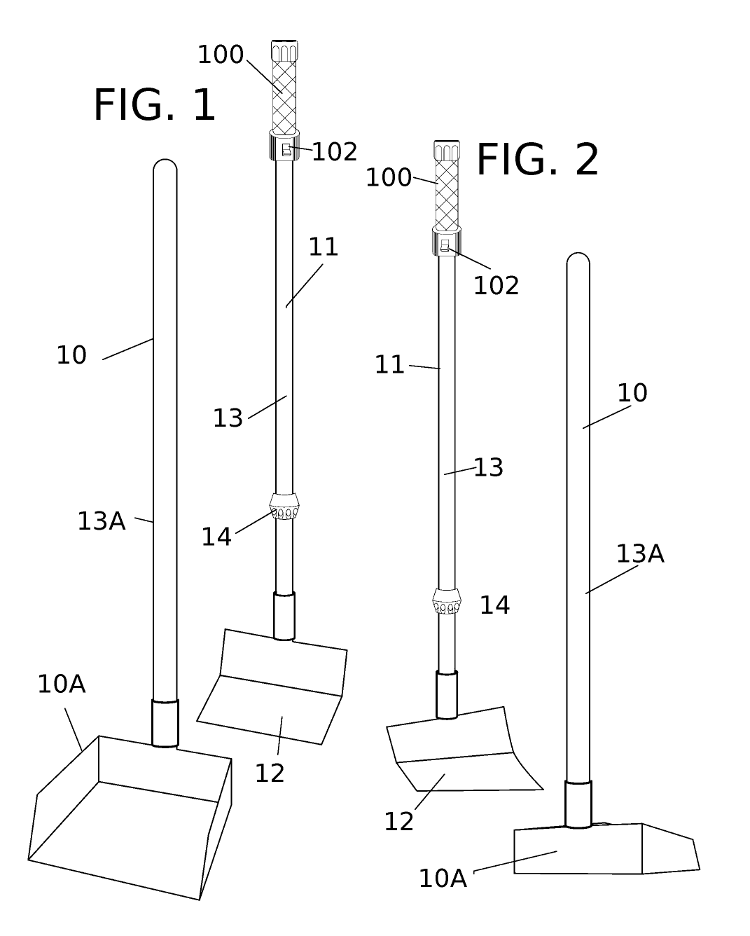

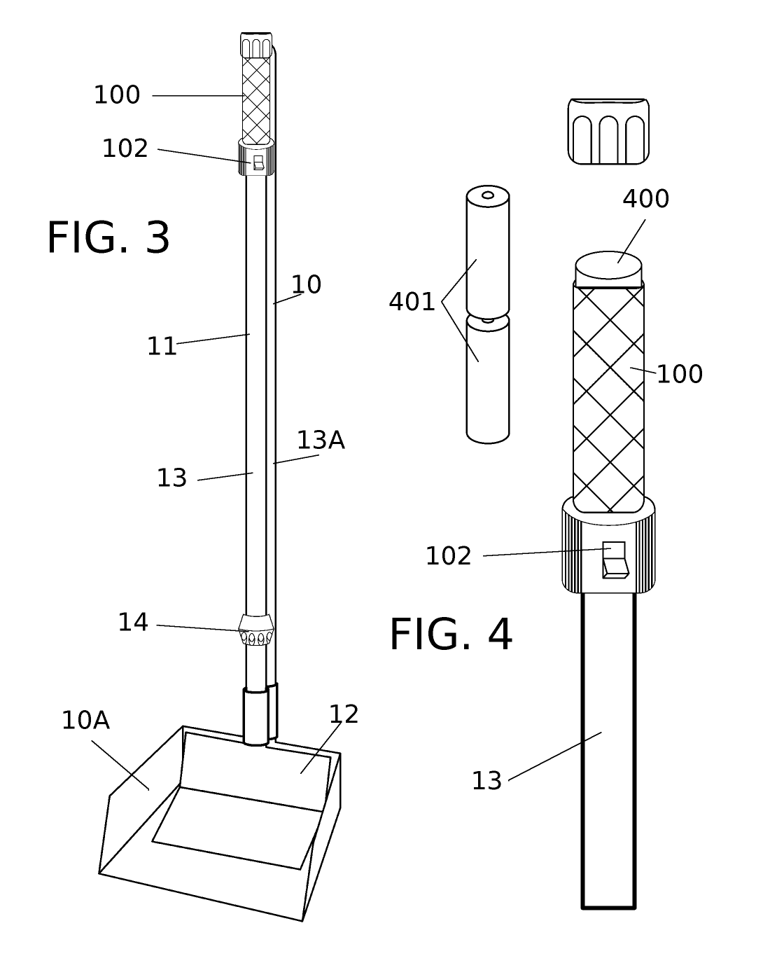

### DETAILED DESCRIPTION OF THE INVENTION

Referring now to the invention in more detail, the invention is directed to an illuminated pet waste collection tool. Components of the first exemplary embodiment include the spatula component 10 and the shovel component 11 of corresponding size and shape. The shovel component 11 is mounted on a long shovel handle 13 having a shovel blade 12 affixed to the lower end, and the spatula component 10 is mounted on a corresponding spatula handle 13A and having a spatula blade 10A affixed to the lower end. The shovel component 11 has affixed thereto a high-powered light-emitting diode (LED) bank 14, which is preferably manufactured from polycarbonate. The LED bank 14 is crush resistant and waterproof, and is preferably powered by one or more batteries 401. A bright, focused beam of light is emitted from the LED bank 14 at the lower end of the shovel handle 13, to illuminate the ground in front of the user. The batteries 401 may be housed in a battery compartment 400, which may be accessed by removing the top of the shovel handle 13 by pulling on or unscrewing a cap, as shown, which is preferably rigid. The top of the shovel handle surrounding the battery compartment 400 is preferably covered in a grip top 100 composed of high friction gripping material.

The switch 102 may be toggled to selectively activate and deactivate the LED bank 14. Light emitted from the LED bank 14 is directed downward at the area immediately in front of and/or behind and/or surrounding the shovel component 11 when the shovel component 11 is held vertically. However, the shovel component 11 may be pointed in any direction in the manner of a flashlight.

To use the first exemplary embodiment, the user equips the device while exercising the dog or other animal outdoors at night, including on the user's own property or on the public street. The user may activate LED bank 14 to aid in locating animal waste or other objects of interest. When collecting animal waste, the user separates the two components and uses the LED bank 14 to locate the animal waste and scrapes the dog waste into the spatula component 10 with the shovel component 11.

The spatula blade 10A, shovel blade 12, and handles 13 and 13A are preferably manufactured from a rigid, durable, lightweight material of substantial strength that is easily cleaned, such as aluminum or high-impact plastic. The LED bank 14 are preferably manufactured from a rigid, durable, lightweight material such as polycarbonate, featuring lenses which are preferably manufactured from a rigid, durable, transparent material, such as methacrylate.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An illuminated pet waste collection tool comprising a shovel component and a spatula component; said shovel component comprising a shovel handle and a shovel blade; said shovel blade being affixed to the lower end of said shovel handle; said spatula component comprising a spatula handle and a spatula blade; said spatula blade being affixed to the lower end of said spatula handle; said shovel component further comprising an LED bank; said LED bank being affixed to said shovel handle; and said LED bank being configured to emit bright light directed downward.

2. The illuminated pet waste collection tool of claim 1 further comprising a switch; said switch being configured to selectively enable or disable said LED bank; and said switch being affixed to the top end of said shovel handle.

3. The illuminated pet waste collection tool of claim 1 wherein the top of said shovel handle is surrounded by a grip top.

4. The illuminated pet waste collection tool of claim 2 wherein the top of said shovel handle is surrounded by a grip top.

5. A method of use of the illuminated pet waste collection tool of claim 1 comprising taking said spatula component and said shovel component along when exercising an animal outdoors at night, using light emitted from said LED bank to locate animal waste on the ground, and scraping animal waste so identified and located from the ground onto said spatula component using said shovel component.

6. A method of use of the illuminated pet waste collection tool of claim 2 comprising taking said spatula component and said shovel component along when exercising an animal outdoors at night, using light emitted from said LED bank to locate animal waste on the ground, and scraping animal waste so identified and located from the ground onto said spatula component using said shovel component.

7. A method of use of the illuminated pet waste collection tool of claim 3 comprising taking said spatula component and said shovel component along when exercising an animal outdoors at night, using light emitted from said LED bank to locate animal waste on the ground, and scraping animal waste so identified and located from the ground onto said spatula component using said shovel component.

8. A method of use of the illuminated pet waste collection tool of claim 4 comprising taking said spatula component and said shovel component along when exercising an animal outdoors at night, using light emitted from said LED bank to locate animal waste on the ground, and scraping animal waste so identified and located from the ground onto said spatula component using said shovel component.
